(19) United States
(12) Patent Application Publication
(10) Pub. No.: US 2011/0198220 A1
(43) Pub. Date: Aug. 18, 2011

(54) Electrolyte sensor using conductive elastomer

(76) Inventors: Saket S. Bhatia, Santa Clara, CA (US); Darell Davis, Sunrise, FL (US)

(21) Appl. No.: 12/658,371

(22) Filed: Feb. 12, 2010

(51) Int. Cl. G01N 27/26

(52) U.S. Cl. 204/400

(57) ABSTRACT

An electrolyte sensor that uses conductive elastomer electrodes. Examples of the intended analytes for sensor use include those found in urine, saliva, blood, feces and spinal fluid, although other analytes exist for electrolyte detection. Conductive elastomer trace electrodes are separated by a gap or channel which can be bridged by an electrolyte and thereby complete an electrical circuit to an alarm or other circuitry. Gap or channel distances vary the level of electrical resistance associated with detecting certain electrolytes.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to the use of conductive elastomers in electronics. More specifically, the present invention relates to electrodes used in sensors. More specifically, the present invention relates to electrodes used in a sensor to detect electrolytes including but not limited to those present in urine, sweat, blood, feces, saliva and spinal fluid.

2. Description of Related Art

The use of conductive polymers and conductive elastomers exists in the prior art commonly in the form of gaskets or seals due to their elasticity and conductivity. Some of the useful properties as a conductor include facile shape formation, corrosion resistance, and air tight contact interface. Use as a conductor is limited however because it is very difficult to obtain as low a resistivity as in metals. Conductive elastomers are typically comprised of silicone rubber that has had conductive carbon or metal particles introduced. The resistivity of the material changes with conductive particle content.

The use of sensor electrodes attached electrically to an alarm unit for the purpose of enuresis therapy is well known in the prior art. Electrolytes present in urine enable completion of an alarm circuit by filling a gap or channel between electrodes and thereby indicating the occurrence of a micturition event. Most prior art electrodes have either a set of parallel or else linear serpentine positive and negative electrode patterns whereby urine must contact both a positive and negative bare wire to complete the alarm circuit. The bare wire is made available for contact with urine through gaps in an insulator whereby the urine must enter a positive and negative gap to contact a wire and complete a circuit (see PCT/JP2006/313995 to Wada, et al.).

Separately to Page are US 2008/0246620 and PCT/NZ2008/000331 which are limited to circuit completion along a single narrow gap between two conductive plastic zone halves, each half respectively in contact with one positive conductive element and one negative conductive element that extend into the sensor body from a terminal socket. This is disadvantageous because an electrolyte could be present in one of the plastic zone halves and never close the electric circuit whereby the entire sensor surface is comprised only of the two zone halves. The present invention is not limited in this way whereby conductive elastomer positive and negative trace electrodes are connected to respective wire terminal lead ends and whereby the conductive elastomer trace electrodes are in close proximity to each other throughout a sensor “trace pattern” so that an electrolyte can close the circuit by simultaneously touching any point along the surface of a positive and a negative trace electrode throughout the entire trace pattern which takes up the entire sensor surface. This is an important improvement given that a penis or other electrolyte source is unpredictable in electrolyte placement and whereby the volume or amount of electrolyte required to close a circuit should be as low as possible and corresponding circuit completion as quick as possible for effective therapy where every moment counts in training the nervous system. Examples of sensor trace patterns are illustrated in FIG. 2A-2L.

Another advantage of the present invention over the prior art is the use of heat molding to attach the trace electrodes. Considerably larger and more robust than prior art sensor films or printed circuits, the present heat molded elastomeric electrodes are able to withstand both being worn overnight by a user as well as degradation by caustic substances such as urine. A “wetness sensor” is described in US 2008/0041792 to Crnkovich, et al. that detects leaks from catheter sites using exclusively a circuit printed onto a solid nonflexible support. Such a circuit would not withstand the caustic effect of urine combined with continuous overnight use by a wearer.

Sensors used to detect electrolytes present in things other than urine would operate on the same principle of forming a conductive bridge between sensor electrodes whereby the function of the completed circuit operates to contribute to different forms of therapy depending on what is being detected by the sensor, the upstream electronics and what human system is being treated. Examples of additional purposes include detecting blood or spinal fluid leaking from catheter sites and sensing feces in a diaper. These examples are not exclusive from other uses but instead are meant to describe some of the utilities for the use of conductive elastomer in sensor electrodes and where it is illustrated that a conductive elastomer electrode is universally an improvement over the current art for many important reasons but especially because electrolytes can contact any part of the surfaces of the robust conductive elastomer trace electrodes and result immediately in a current whereas the prior art requires additional time for electrolytes to come into contact with interspersed metal wire contact points or be of sufficient volume and directionality to connect plastic electrode zone halves.

### SUMMARY OF THE INVENTION

The present invention is a sensor for detecting electrolytes including but not limited to those present in urine, sweat, saliva, feces, spinal fluid and blood and is capable of acting as a sensor for any electrolyte. It is to be understood that the term ‘electrolyte’ includes but is not limited to those electrolytes present in sweat, blood, urine, feces, saliva or spinal fluid. An example of the utility for the present invention is in the area of enuresis treatment whereby the sensor is attached to an alarm circuit that is activated by the presence of urine on the sensor. The sensor is comprised of positive and negative conductive elastomer trace electrodes, a base portion or portions, and a gap or channel or pluralities thereof separating said electrodes. The “positive” and “negative” trace electrodes are defined as those electrodes which are respectively connected to positive and negative wire terminal leads which are in turn ultimately connected to positive and negative battery terminals. The conductive elastomer trace electrodes are preferably heat molded over a highly flexible non conductive silicone base portion whereby a gap or channel separates positive from negative trace electrodes throughout the pattern. The trace electrodes may sit on top of the base portion or may be recessed into the base portion; the gap or channel may comprise a spatial void using available air as a gaseous insulator or, whereby recessed electrodes are separated by a gap or channel comprised of physical insulating material such as the silicone in the base portion. Said gap or channel is not limited to an even size whereby gaps or channels may be of even or uneven size or sizes throughout the trace pattern. Electrolytes such as those present in urine make a conductive bridge across the channel or gap between adjacent positive and negative traces causing a circuit to be closed whereby the electrolytes present in urine are capable of conducting an electric charge between the positive and negative trace electrodes. Said circuit is closed in connection with either an alarm unit or a transmitter capable of sending a signal to a remote alarm or other electronics unit.

It is therefore a purpose of the present invention to comprise an electrolyte sensor.

It is another purpose of the present invention to improve the speed with which a sensor for detecting an electrolyte alarms the presence of said electrolyte by making sensor electrodes out of conductive elastomer whereby the conductive elastomer is able to conduct a current at any point along its entire surface whereby an electrical circuit is closed between a positive conductive elastomer electrode and a negative conductive elastomer and whereby said positive and negative electrodes are connected to a power source with metal wires, additional portions of conductive elastomer or in any manner whereby a current is supplied to the sensor portion electrodes.

It is another purpose of the present invention to improve the specificity of the sensor to react to a desired electrolyte by making electrolyte sensor electrodes out of conductive elastomer whereby the elastomer composition and the size of the gap or channel between electrode traces is a function of the amount of electrical resistance required to be overcome in forming a current across the gap.

It is another purpose of the present invention to improve the functional shape of a urine sensor by making urine sensor electrodes out of conductive elastomer and connecting them via a trace pattern to a highly flexible silicone base portion whereby the penis can change positioning during the night and whereby conductive elastomer electrode traces can be patterned to detect urine over a useful area of virtually any shape.

It is another purpose of the present invention to improve the state of the art of electrolyte detection by lessening the amount of electrolyte required to activate an electrolyte sensor by making electrolyte sensor electrodes out of conductive elastomer.

It is another purpose of the present invention to improve the flexibility of electrolyte sensors by making electrolyte sensor electrodes out of conductive elastomer and with a flexible silicone base portion or bridge portions.

It is another purpose of the present invention to improve the comfort of electrolyte sensors worn by users by making electrolyte sensor electrodes out of conductive elastomer and the base portion out of flexible silicone by virtue of inherent properties of elastomer including relative warmth to the touch, and whereby the silicone base portion is made with soft rounded edges and corners. Also adding to the comfort is the replacement of metal in the sensor surface with elastomer thereby minimizing the use of hard, sharp materials in sensor construction.

It is another purpose of the present invention to improve the durability of electrolyte sensors through heat molding electrolyte sensor electrodes and lead wires to a silicone base.

It is another purpose of the present invention to improve the corrosion resistance of electrolyte sensors by making electrolyte sensor electrodes out of conductive elastomer instead of metal wires.

The characteristics and utilities of the present invention described in this summary and the detailed description below are not all inclusive. Many additional features and advantages will be apparent to one of ordinary skill in the art given the following drawings, specifications and claims.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1 is a perspective view showing the incoming electrode wire terminals attached to a base member and the electrode traces.

FIGS. 2A-M show various electrode trace patterns as examples of the patterns made available by the present invention.

FIG. 3 is an exploded side view of a sensor with an island type electrode pattern.

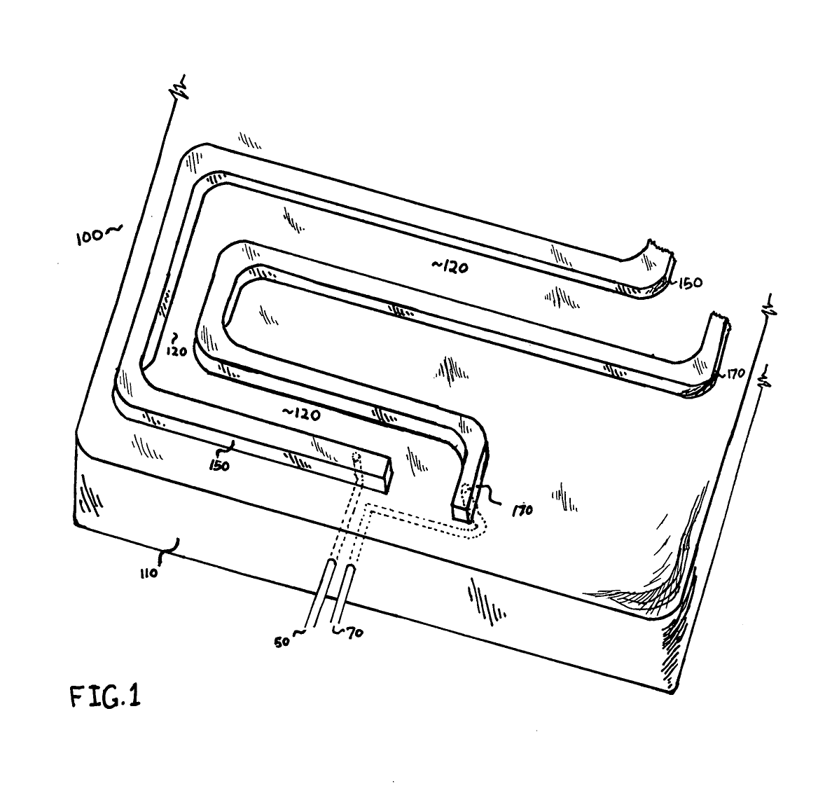

### DETAILED DESCRIPTION

The present invention is an electrolyte sensor that is preferably used for the detection of sweat, blood, urine, feces, saliva and spinal fluid, all containing electrolytes capable of enabling conduction of an electric current between electrodes and it is to be understood that the term ‘electrolyte’ includes but is not limited to those present in the following analytes: sweat, blood, urine, feces, saliva or spinal fluid. The present invention is also generally intended to allow the measurement of electrical resistance across electrode gaps of any possible analyte.

The advantages contained herein come by making electrolyte sensor electrodes with conductive elastomer and enjoying the properties which that allows including flexibility in designing sensor shape and area (relating, for example, to penis or urine or electrolyte source location variability), improved conductive sensitivity to electrolytes as a function of electrode area versus reaction time, sensor corrosion resistance, sensor conductive exclusivity to sweat, blood, urine, feces or spinal fluid, sensor flexibility and comfort, and sensor durability due to heat molded construction.

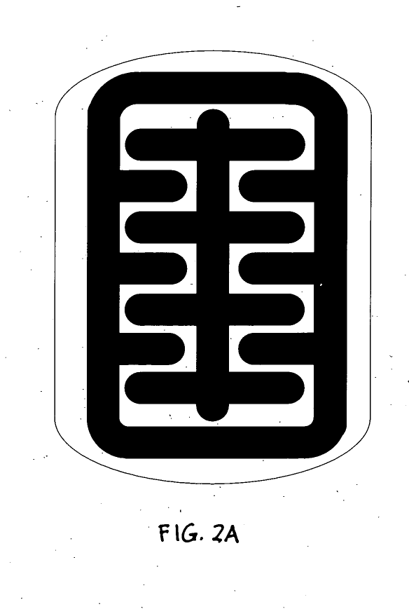

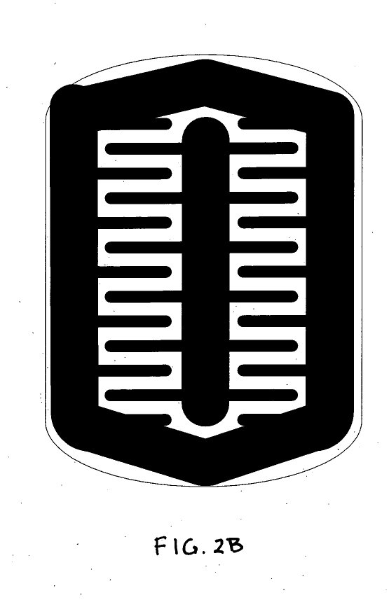

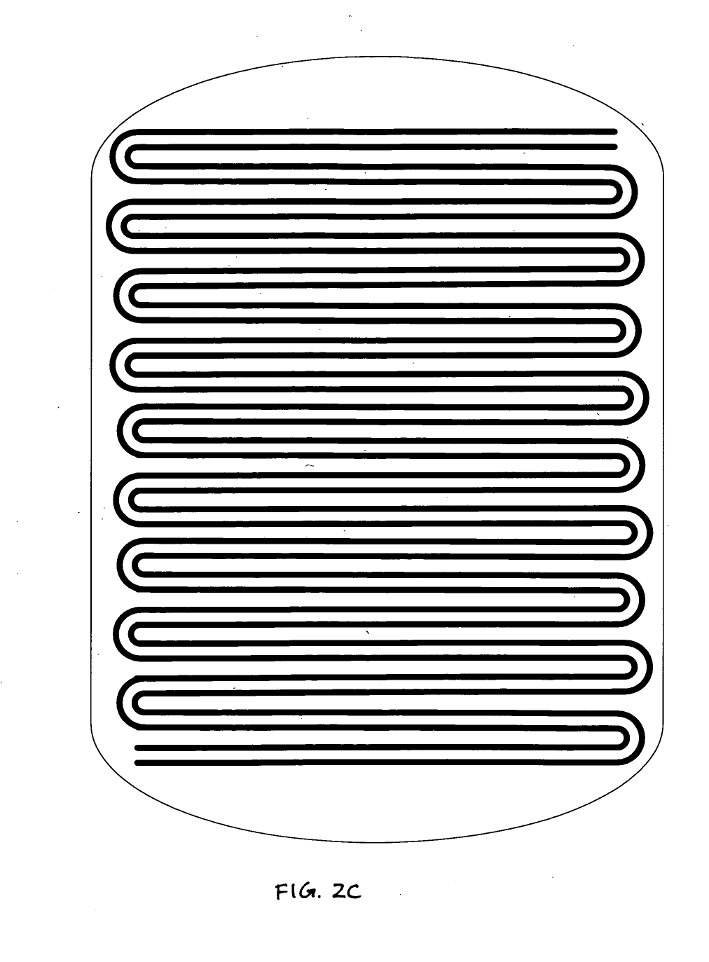

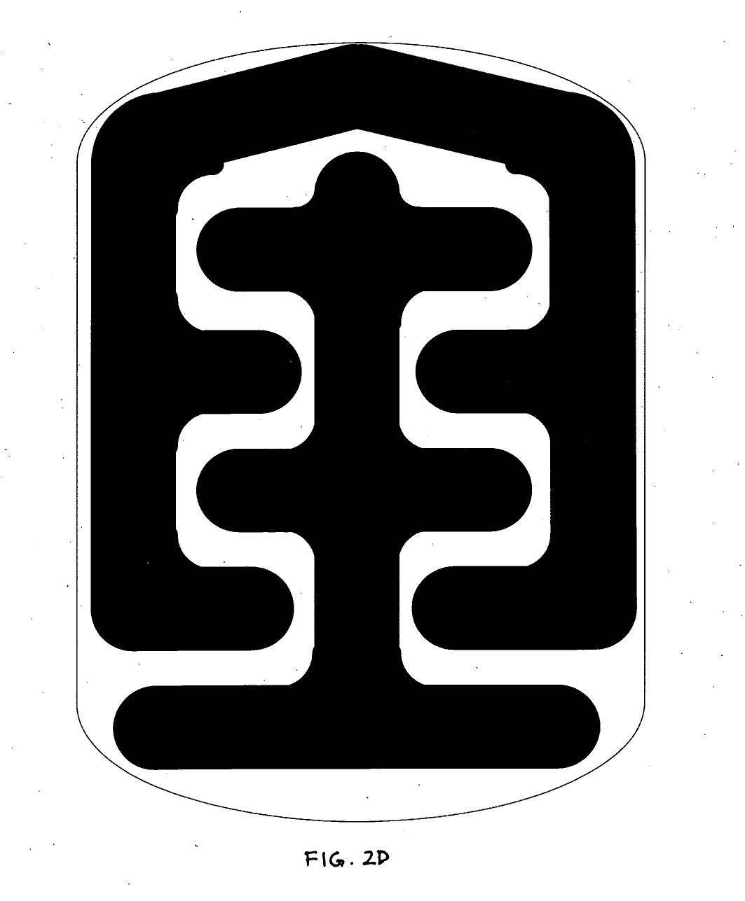

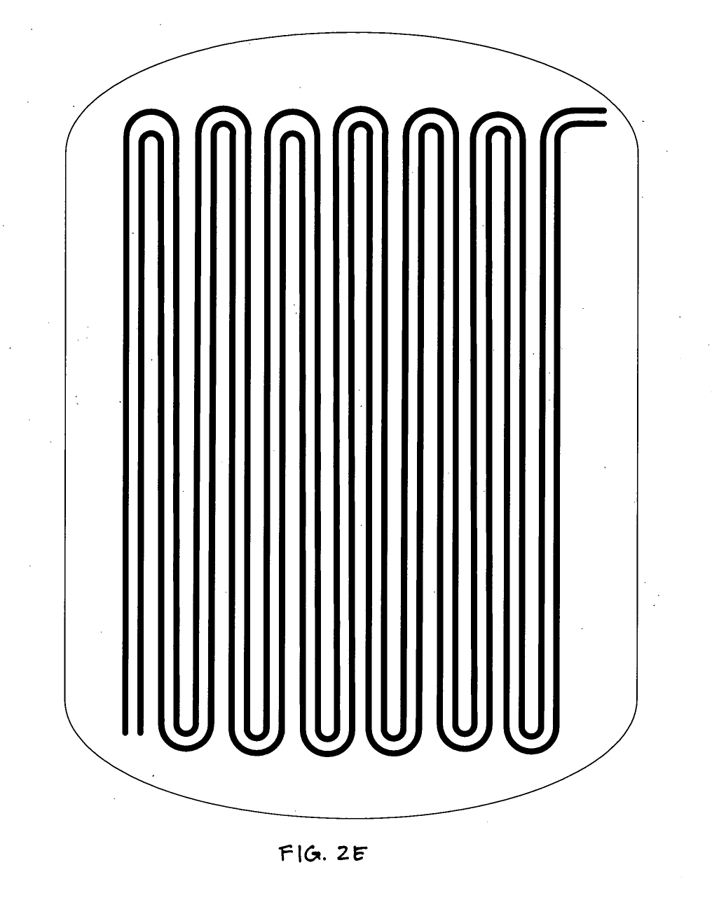

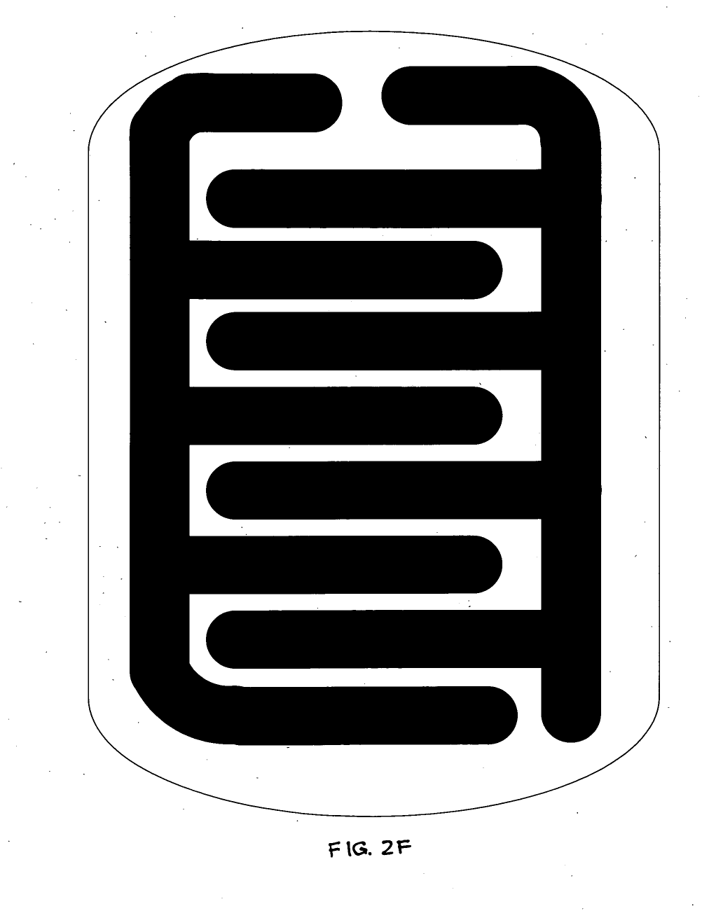

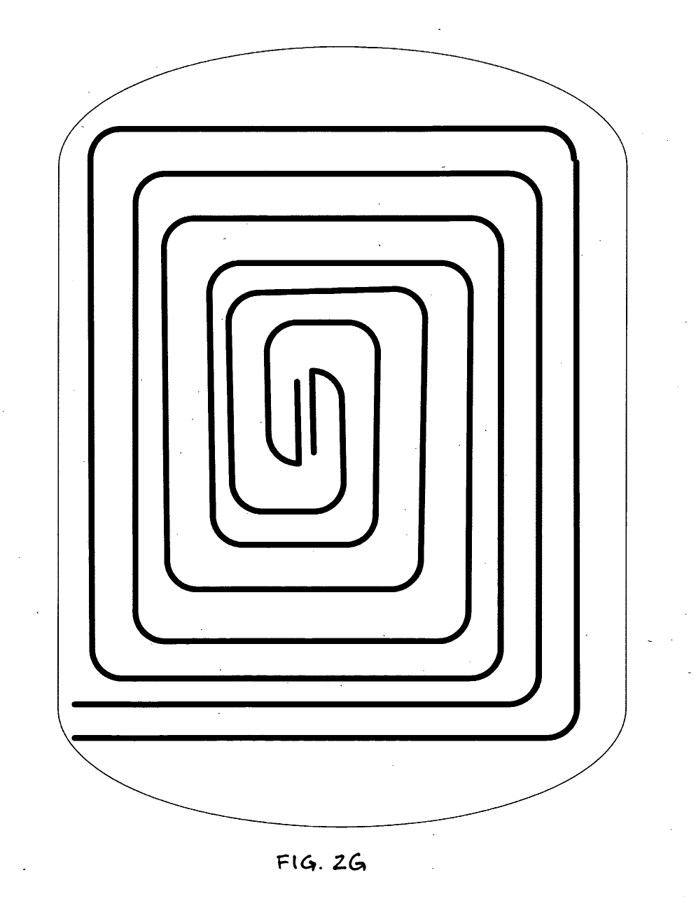

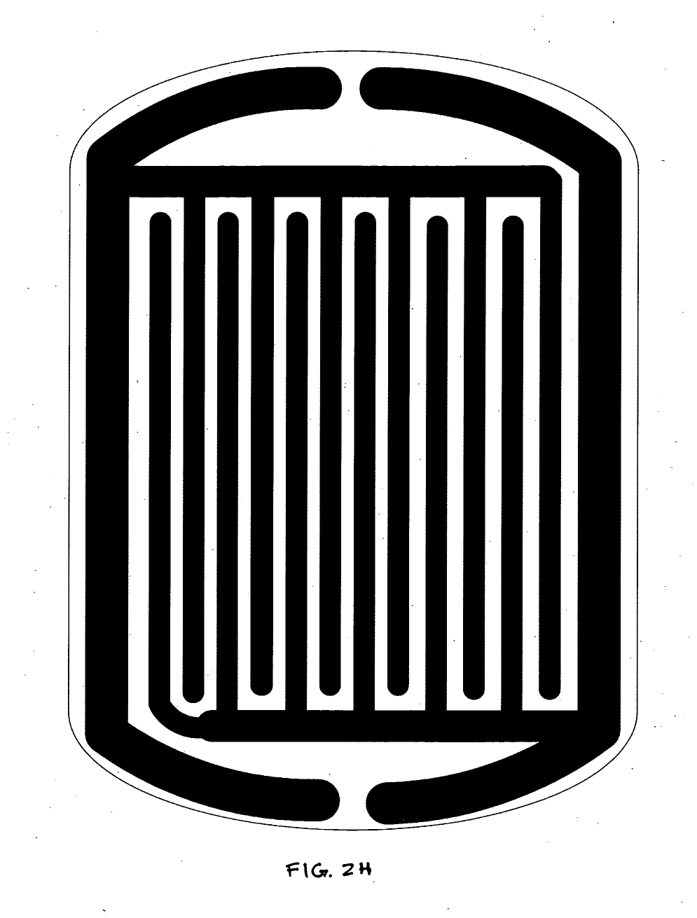

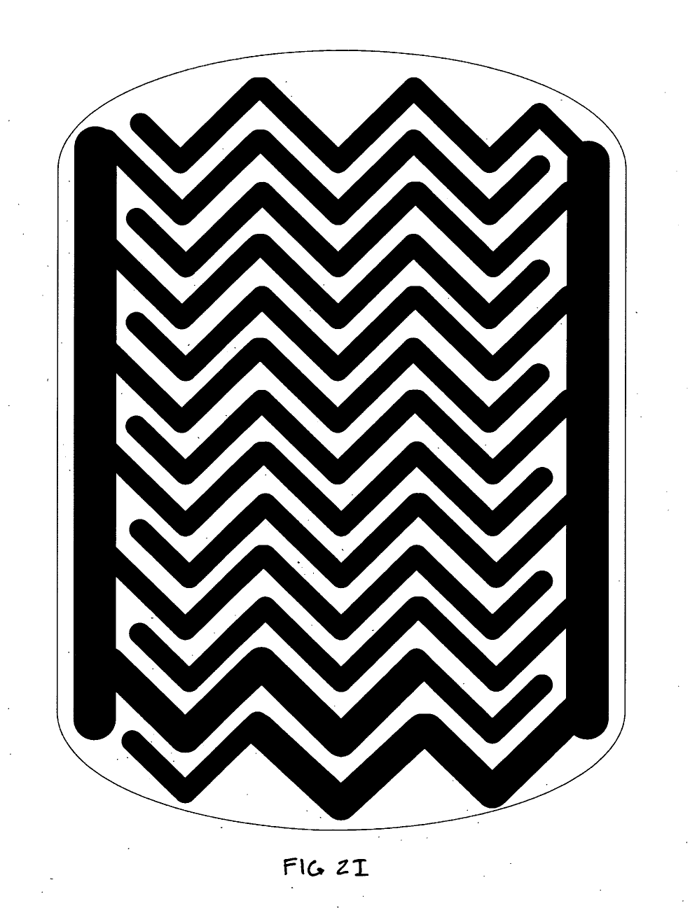

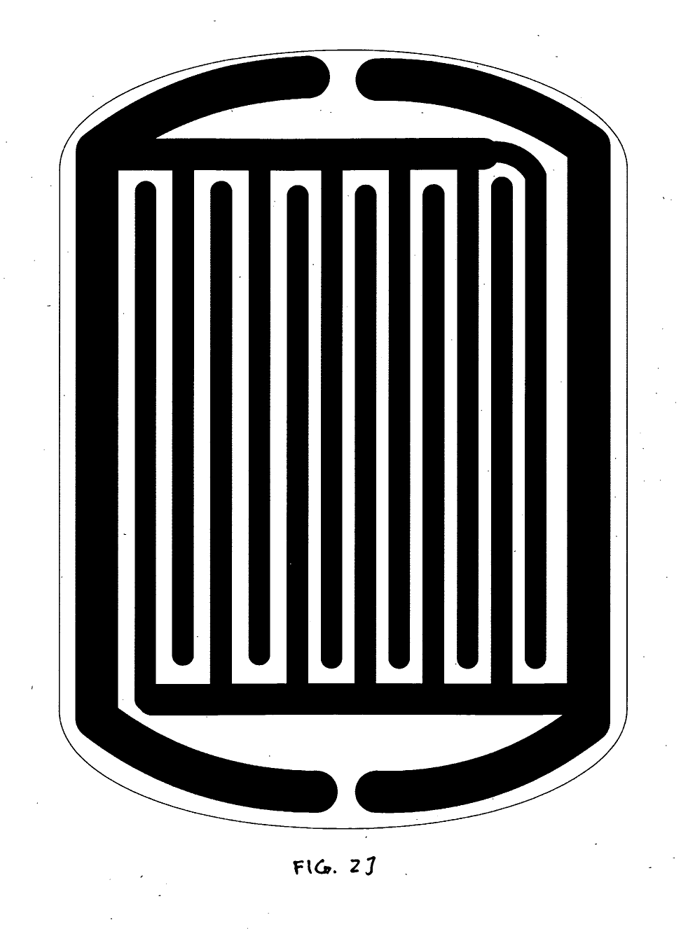

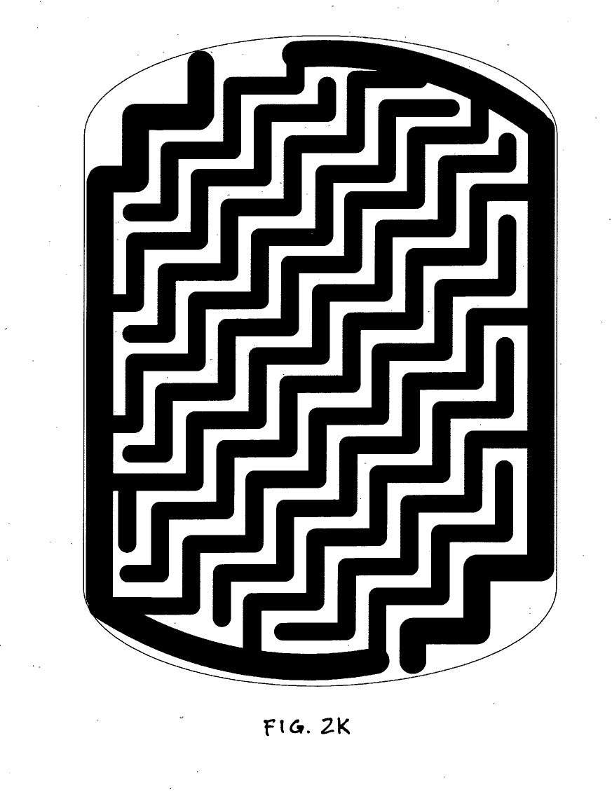

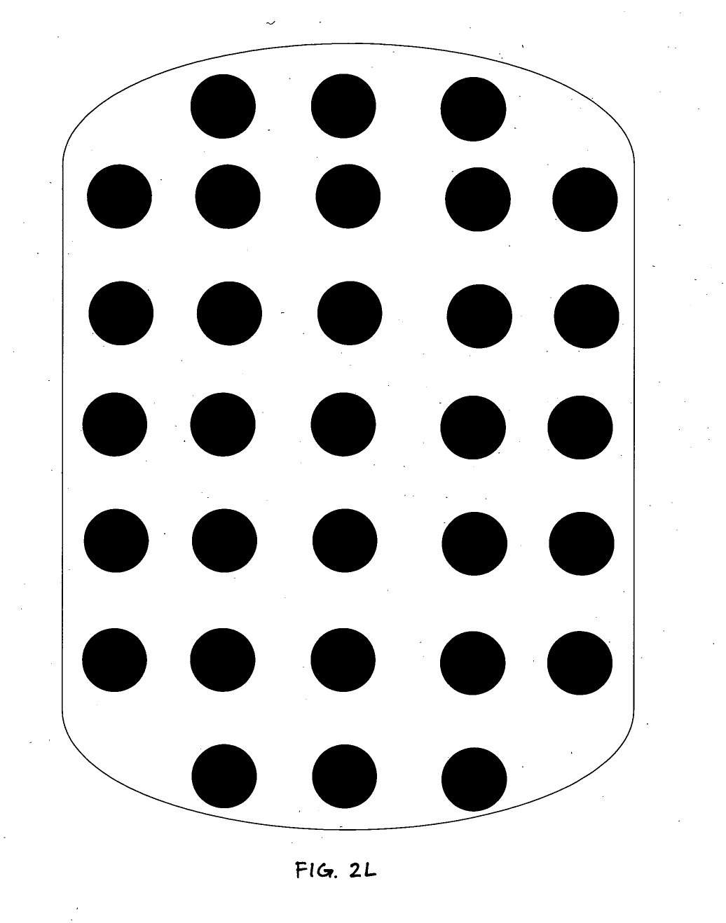

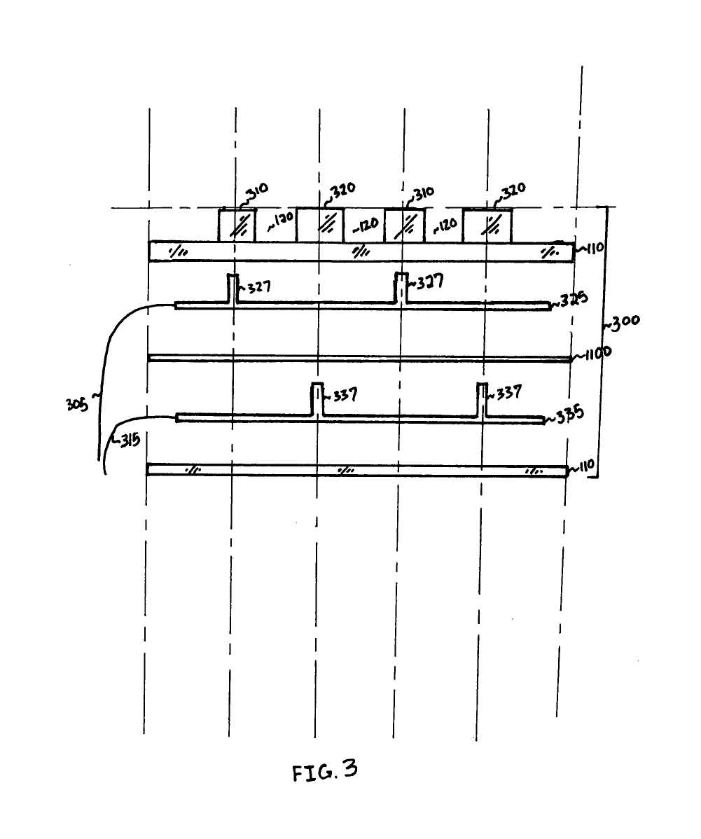

Along with linear style trace electrodes, herein “trace electrodes”, is an additional preferred embodiment for electrode pattern design comprising a plurality of spaced apart “electrode islands”, herein “islands”. See FIG. 2L and FIG. 3. Sensor composition, whereby an island pattern is used, comprises connecting terminal wires 305, 315 to separate positive and negative overlaid planar conductive grids 325, 335 that are separated from each other by an insulating layer 1100 within the base portion 110. The planar grids 325, 335 have corresponding small positive and negative posts 327, 337 that protrude perpendicularly from the planar grids and through insulating material to an outer surface of the base portion 110. Said positive and negative protruding posts are positionally offset to one another and elastomer is heat molded to each. The result is a plurality of elastomeric island electrodes 310, 320 that are alternating cylindrical or non-cylindrical positive and negative electrodes separated physically and electrically by gaps 120 which may be then filled with or distanced across by electrolyte whereby a circuit may be closed.

The chemical process for producing conductive elastomer is well known in the art and principally comprises mixing elastomer with conductive particles. It should be understood that numerous equivalent compounds could be used to create elastomeric compounds capable of forming a suitable positive or negative electrode. Additionally, the compounds used may be classified as polymeric as opposed to elastomeric, however, the preferred embodiment is elastomeric. The preferred embodiment of the elastomer composition for the present invention is indicated in a chart below.

Means for separating positive and negative trace electrodes 150, 170 or islands 310, 320 in order to maintain the desired distance or distances between electrodes include but are not limited to the preferred method of heat molding the electrode traces 150, 170 or islands 310, 320 to a base member 110 at a desired distance or distances from each other, and alternatively the use of non conductive “bridges” between electrodes whereby a base portion may or may not be used. The preferred embodiment is use of the non conductive silicone base member 110 whereby the incoming terminal leads 50, 70 or 305, 315 are connected to the trace electrodes 150, 170 or islands 310, 320 by heat molding to said electrode traces or islands and the base member 110 to prevent or make difficult the dislodgement of the terminal ends in use. Bare terminal wire leads 50, 70 or 305, 315 are positioned proximally to a portion of a respective electrode. Silicone from a silicone base portion 110 is melted around the bare terminal wires 50, 70 or 305, 315 and the connection vulcanized. Heat molding the terminals 50, 70 or 305, 315 to the electrodes has the additional advantage of freeing manufacture of the sensor from the physical and financial constraints associated with shaping metal wires into a trace pattern in favor of an elastomer trace mold.

Heat molding is also the preferred means for connecting the wire terminals 50, 70 or 305, 315 to the silicone base portion. The present invention also anticipates use of rivets, screws, frictional and/or compression connecting means.

It is anticipated that said terminal wires 50, 70 or 305, 315 may be connected directly to an alarm or other electronics unit or that said terminal wires may be connected to a transmitter unit which may transmit to a remote alarm or other electronics unit. It is separately anticipated that the sensor 100 may have more than one sensing surface whereby the base portion 110 may contain more than one surface upon which to place elastomer trace electrodes with same or different trace patterns on said surfaces.

Conductive elastomer traces comprising the positive and negative trace electrodes 150, 170 or islands 310, 320 are arranged with a channel or gap 120 separating said positive and negative trace electrodes whereby the channel or gap distance is defined as the distance between a positive electrode or portion thereof and the nearest negative electrode or portion thereof. The size of said channel or gap distance between said electrodes is defined as a functional size that is determined by the conductive ability of electrolytes to quickly form a circuit bridge between said positive and negative conductive elastomer trace electrodes whereby without said electrolytes the channel or gap distance size would cause the circuit to remain open. It is anticipated that the electrolytes can bridge positive and negative electrodes that are not only one gap or channel distance from each other but may alternatively bridge positive and negative traces separated by numerous gaps or channels, or may employ gap or channel distances of uneven size or sizes. It is therefore established that the anticipated embodiments of the gap or channel distance between traces, and the related embodiments of trace widths or areas, are to be understood to comprise a functional value limited only by the conductivity of a given electrolyte across a certain distance and between electrodes carrying current of a certain resistance level. The non-limiting preferred embodiment for the distance between positive and negative electrodes comprising the gap or channel distance is 1-20 mm, and the preferred embodiment for the size of trace widths or diameters is 1-20 mm.

It is further to be understood that the present invention anticipates unequal size gaps or channel distances, as well as varying trace sizes in the same sensor. However, the preferred embodiment is to have trace electrode patterns with gap or channel distances and/or trace widths or diameters that operate within a size range as needed for detection of a given electrolyte. See FIGS. 2A-2L.

It is also to be understood that the present invention anticipates an embodiment whereby non conductive silicone or an equivalent material is employed to form small bridges placed at functional intervals that function to separate the conductive elastomer trace electrodes from each other thereby establishing and maintaining the gap or channel or a plurality of gaps or channels between electrodes. However, it is the preferred embodiment of the present invention to utilize a non conductive silicone base 110 as the separation means to create the gap or channel 120 between electrode traces whereby the conductive elastomer traces 150, 170 or islands 310, 320 are attached to a non conductive silicone base 110 in such a manner that a gap or channel 120 is established between them and whereby the preferred attachment means for attaching the electrode traces to the base is heat molding. The preferred compositions for the conductive elastomer traces and the silicone base are shown in the charts below:

Conductive Elastomer

| | |
|---|---|
| Silicone: Methyl Vinyl Silicone Rubber | 57% |
| (Dimethyl Polysiloxane) | |
| Conductive Carbon Black: Acetylene Carbon | 42% |
| (Acetylene Black) | |
| Hardener: 2.5-2.5-2-methyl t-butyl peroxy-2 | 1% |
| ethane (Dimethyl-2.5 Di(Tertiary-Butyl Peroxy)Hexane) | |

Insulating Rubber Silicone Base (Sensor Base)

| | |
|---|---|
| Silicone: Methyl Vinyl Silicone Rubber | 99% |
| (Dimethyl Polysiloxane) | |
| Hardener: 2.5-2.5-2-methyl t-butyl peroxy-2 | 1% |
| ethane (Dimethyl-2.5 Di(Tertiary-Butyl Peroxy)Hexane) | |

Given the above functional definition for electrode trace embodiments, it is possible for numerous trace patterns with correlating gaps or channels between positive and negative conductive elastomer traces to function equivalently. Some of these examples are represented in FIGS. 2A-2L. It is to be understood therefore that those trace patterns using the above functional definition are equivalents to one another and that the preferred embodiment is to be understood more precisely as a range of values for gap or channel distance and related trace width or area (diameter).

The previous is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

What is claimed is:

1. An electrolyte sensor comprising:
1. A positive trace electrode or electrodes comprised of conductive elastomer or conductive polymer whereby said electrode or electrodes are employed in a sensor pattern.
2. A negative trace electrode or electrodes comprised of conductive elastomer or conductive polymer whereby said electrode or electrodes are employed in a sensor pattern.
3. A gap or channel separating the positive electrode or electrodes of claim 1 from the negative electrode or electrodes of claim 2 whereby:
said gap or channel is of sufficient dimension to prevent an electric current from being established between the positive electrode or electrodes of claim 1 and the negative electrode or electrodes of claim 2;
said gap or channel may be used in a plurality between the positive electrode or electrodes of claim 1 from the negative electrode or electrodes of claim 2 to prevent said electric current from being established;
said gap or channel may of uneven dimension;
said gap or channel may be employed in the sensor pattern of claim 1 and claim 2 in order to separate island type electrodes;
said gap or channel being of sufficient size or sizes to allow the measuring of electrical resistance of any solid, liquid or gas or combination thereof across said gap or channel;
said gap or channel being of sufficient size or sizes to allow an electrolyte or electrolytes present in a solid, liquid or gas or any combination thereof to conduct electricity or carry an electric charge or carry an electric current between the positive electrode or electrodes of claim 1 and the negative electrode or electrodes of claim 2;
said gap or channel being utilized between the positive electrode or electrodes of claim 1 and the negative electrode or electrodes of claim 2 to form a trace pattern with said electrode or electrodes;
said gap or channel is comprised of a solid, liquid or gas or a combination thereof; and
said gap or channel is established by a means for separating the positive electrode or electrodes of claim 1 from the negative electrode or electrodes of claim 2.
4. The separating means of claim 3 including but not limited to:
attaching the positive electrode or electrodes of claims 1 and 3 and the negative electrode or electrodes of claims 2 and 3 at a distance from each other by attachment means to a flexible non conductive base portion whereby said gap or channel is established between said positive electrode or electrodes and said negative electrode or electrodes; and
employing small non conductive bridges between the positive electrode or electrodes of claims 1 and 3 and the negative electrode or electrodes of claims 2 and 3 of sufficient plurality and of sufficient rigidity to maintain said gap or channel.
5. The attachment means of claim 4 including but not limited to:
heat molding and vulcanization; and
appropriate adhesives.
